(19) United States
(12) Patent Application Publication
(10) Pub. No.: US 2013/0334578 A1
(43) Pub. Date: Dec. 19, 2013

(54) MOLECULE SENSOR DEVICE

(71) Applicant: NATIONAL TAIWAN UNIVERSITY, Taipei City (TW)

(72) Inventors: CHE-WEI HUANG, TAOYUAN COUNTY (TW); YU-JIE HUANG, TAIPEI CITY (TW); PEI-WEN YEN, NEW TAIPEI CITY (TW); HSIAO-TING HSUEH, KAOHSIUNG CITY (TW); SHEY-SHI LU, TAIPEI CITY (TW); CHIH-TING LIN, TAIPEI CITY (TW)

(73) Assignee: NATIONAL TAIWAN UNIVERSITY, Taipei City (TW)

(21) Appl. No.: 13/870,009

(22) Filed: Apr. 25, 2013

Related U.S. Application Data
(60) Provisional application No. 61/659,434, filed on Jun. 14, 2012.

(51) Int. Cl. G01N 27/414

(52) U.S. Cl. CPC G01N 27/4145; Y10S 977/762; Y10S 977/92; B82Y 15/00
USPC 257/253; 977/762; 977/920

(57) ABSTRACT

A molecule sensor included in a molecule sensor device has a semiconductor substrate, a bottom gate, a source portion, a drain portion, and a nano-scale semiconductor wire. The bottom gate is for example a poly-silicon layer formed on the semiconductor substrate and electrically insulated from the semiconductor substrate. The source portion is formed on the semiconductor substrate and insulated from the semiconductor substrate. The drain portion is formed on the semiconductor substrate and insulated from the semiconductor substrate. The nano-scale semiconductor wire is connected between the source portion and the drain portion, formed on the bottom gate, insulated from the bottom gate, and has a decoration layer thereon for capturing a molecular. The source portion, drain portion, and nano-wire semiconductor wire are for example another poly-silicon layer. The bottom gate receives a specified voltage to change an amount of surface charge carriers of the nano-scale semiconductor wire.

### BACKGROUND

1. Technical Field

The present disclosure relates to a sensor, in particular, to a molecule sensor device for detecting molecules.

2. Description of Related Art

Molecule detection can be widely used in many aspects such as disease analysis and post-operative care. However, the conventional molecule detecting systems have to be operated by dedicated technicians in a hospital or a laboratory of a testing institution due to complex operation and expensive instruments so that the cost of medical care is keeping high and the illness condition analysis is over delayed.

A nano-scale molecule sensor is provided in current market to detect all kinds of molecules such as proteins, viruses, medical molecules, chemical molecules, gas molecules or deoxyribonucleic acid (DNA). The molecule sensor can be implemented on a silicon substrate based on the semiconductor fabrication technology and integrated with an interface circuit into a molecule sensor device by the system on chip technology to have the advantage of low cost.

### SUMMARY

An exemplary embodiment of the present disclosure provides a molecule sensor device. The molecule sensor device comprises at least one molecule sensor. The molecule sensor comprises a semiconductor substrate, a bottom gate, at least one source portion, at least one drain portion and at least one nano-scale semiconductor wire. The bottom gate is a single-crystal silicon layer, a poly-silicon layer, or a metal layer formed on the semiconductor substrate and electrically insulated from the semiconductor substrate. The source portion is formed on the semiconductor substrate and electrically insulated from the semiconductor substrate. The drain portion is formed on the semiconductor substrate and electrically insulated from the semiconductor substrate. The nano-scale semiconductor wire is connected between the source portion and the drain portion, formed on the bottom gate, electrically insulated from the bottom gate, and has a decoration layer thereon for capturing at least one molecule. The source portion, the drain portion and the nano-scale semiconductor wire are another single-crystal silicon layer or poly-silicon layer. The bottom gate receives a specified voltage to change an amount of surface charge carriers of the nano-scale semiconductor wire.

An exemplary embodiment of the present disclosure provides a molecule sensor device. The molecule sensor device comprises at least one molecule sensor. The molecule sensor comprises a semiconductor substrate, at least one source portion, at least one drain portion, at least one nano-scale semiconductor wire and at least one side gate. The source portion is formed on the semiconductor substrate and electrically insulated from the semiconductor substrate. The drain portion is formed on the semiconductor substrate and electrically insulated from the semiconductor substrate. The nano-scale semiconductor wire is connected between the source portion and the drain portion, formed on the bottom gate, electrically insulated from the bottom gate, and has a decoration layer thereon for capturing at least one molecule. The side gate is formed on the semiconductor substrate, electrically insulated from the semiconductor substrate and located at one side of the nano-scale semiconductor wire. The source portion, the drain portion, the nano-scale semiconductor wire and the side gate can be a single-crystal silicon layer or a poly-silicon layer. The side gate receives a specified voltage to change an amount of surface charge carriers of the nano-scale semiconductor wire.

To sum up, the present disclosure provides a molecule sensor device. The molecule sensor device comprises at least one molecule sensor. The molecule sensor comprises a bottom gate or a side gate to receive a specified voltage to increase the sensitivity and the accuracy thereof.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a solid diagram of a molecule sensor in an embodiment of the present disclosure.

FIG. 2 is a cross-sectional view of the molecule sensor in FIG. 1 along the AA profile.

FIG. 3 is a schematic view illustrating a Wheatstone bridge of a molecule sensor device for detecting sense signals in an embodiment of the present disclosure.

FIG. 4 is a block diagram illustrating a molecule sensor device in an embodiment of the present disclosure.

FIG. 5 is a plane chart illustrating a single chip of a molecule sensor device in an embodiment of the present disclosure.

FIG. 6 is a solid diagram of a molecule sensor in another embodiment of the present disclosure.

### DESCRIPTION OF THE EXEMPLARY EMBODIMENTS

An exemplary embodiment of the present disclosure provides a molecule sensor which is implemented on a semiconductor substrate (e.g., a silicon substrate) based on the semiconductor fabrication technology and a device thereof. The molecule sensor device comprises a nano-scale semiconductor wire (e.g., a poly-silicon nano-scale semiconductor wire) for sensing molecules (e.g., proteins, viruses, medical molecules, chemical molecules, gas molecules or deoxyribonucleic acid) and a bottom gate or a side gate for controlling the sensitivity and the accuracy of the molecule sensor device. When a specified voltage is applied to the bottom gate or the side gate, the specified voltage contributes to increasing the sensitivity and the accuracy rather than affecting an interface circuit and other components of the molecule sensor device so that the sensing ability of the molecule sensor device can be further increased.

In an exemplary embodiment of the present disclosure, a molecule sensor device with a bottom gate may be implemented by the 0.35 micrometer semiconductor fabrication technology that has two poly-silicon layers and four metal layers. A molecule sensor device with a side gate or a substrate gate may be implemented by the 0.04, 0.09 or 0.18 micrometer semiconductor fabrication technology that has single one poly-silicon layer and six metal layers or by current advanced fabrication technology. In addition, the sensor molecule device of an exemplary embodiment of the present disclosure can be integrated with an interface circuit into a single chip by the system on chip technology, which has the advantages such as operability with low threshold, high sensitivity, low cost, low power consumption and portability, and is adapted to be used in home health care.

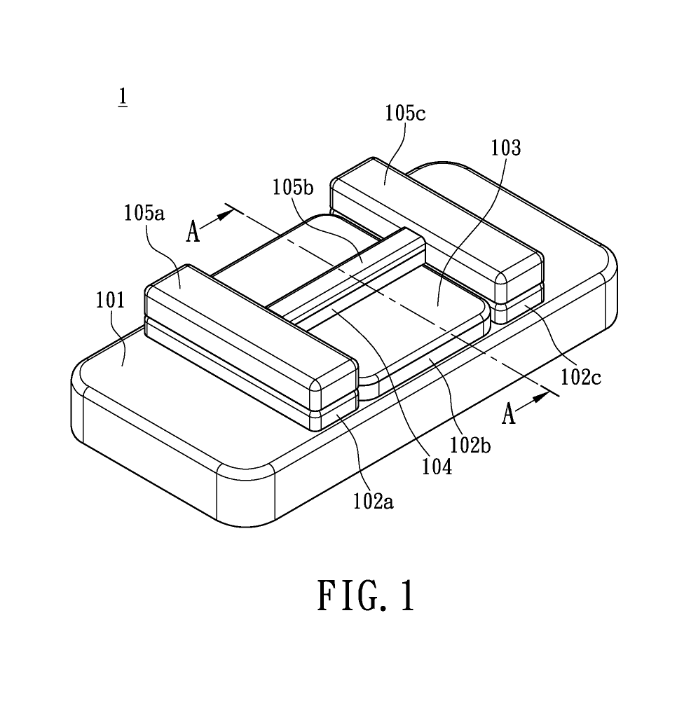

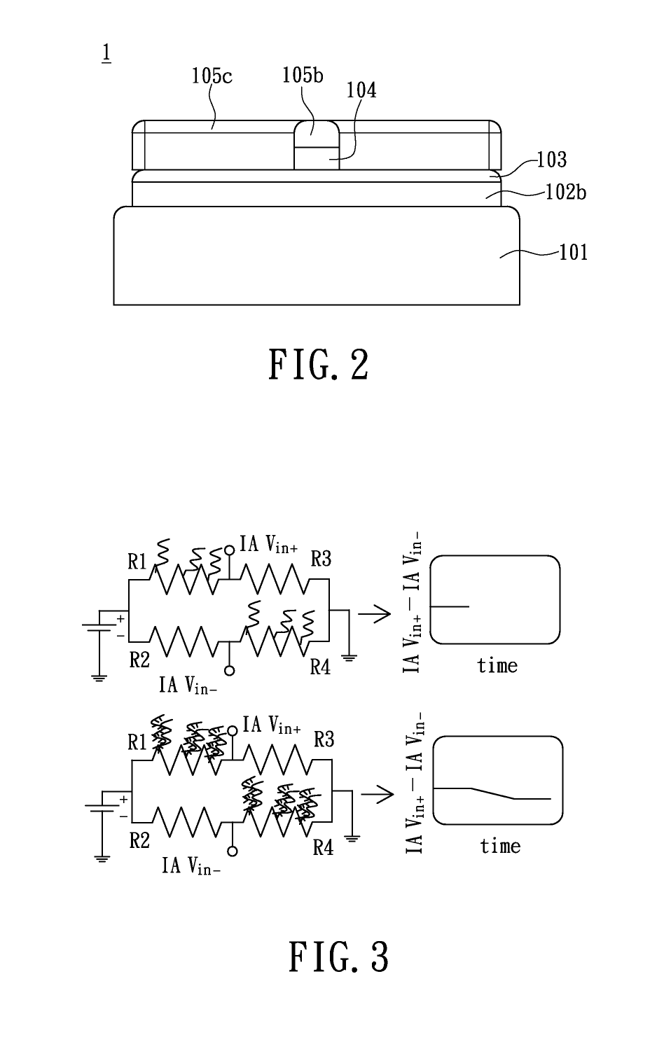

Firstly, referring to FIG. 1 and FIG. 2, FIG. 1 is a solid diagram of a molecule sensor in an embodiment of the present disclosure, and FIG. 2 is a cross-sectional view of the molecule sensor in FIG. 1 along the AA profile. The molecule sensor device comprises at least one molecule sensor 1. The molecule sensor 1 comprises a semiconductor substrate 101, a source insulating portion 102a, a gate insulating portion 102b, a drain insulating portion 102c, a bottom gate 103, a nano-scale semiconductor wire insulating portion 104, a source portion 105a, a nano-scale semiconductor wire 105b and a drain portion 105c.

The source insulating portion 102a, the gate insulating portion 102b and the drain insulating portion 102c are formed on the semiconductor substrate 101 and can be made from the same insulating layer. The bottom gate 103 is form on the gate insulating portion 102b. The gate insulating portion 102b is configured to electrically insulate the bottom gate 103 from the semiconductor substrate 101. The material of the bottom gate 103 is poly-silicon and the nano-structure thereof is substantially a first poly-silicon layer. The nano-scale semiconductor wire insulating portion 104 is located on the bottom gate 103, and the nano-scale semiconductor wire 105b is located on the nano-scale semiconductor wire insulating portion 104. The nano-scale semiconductor wire insulating portion 104 is configured to electrically insulate the bottom gate 103 from the nano-scale semiconductor wire 105b.

The source portion 105a and the drain portion 105c are located on the source insulating portion 102a and the drain insulating portion 102c respectively. The nano-scale semiconductor wire 105b is connected between the source portion 105a and the drain portion 105c. The source insulating portion 102a is configured to electrically insulate the source portion 105a from the semiconductor substrate 101. The drain insulating portion 102c is configured to electrically insulate the drain portion 105c from the semiconductor substrate 101. The materials of the source portion 105a, the nano-scale semiconductor wire 105b and the drain portion 105c are poly-silicon and the nano-structure thereof is substantially a second poly-silicon layer.

It should be appreciated that, the surface of the nano-scale semiconductor wire 105b is attached a decoration layer for bonding molecules by chemical means. When molecules approach the decoration layer, it will be captured by the decoration layer so that the electrical characteristics of the nano-scale semiconductor wire 105b such as resistance, capacitance or inductance will be changed due to the charged molecules. Briefly speaking, the decoration layer on the surface of the nano-scale semiconductor wire 105b is configured as the sensing region of the molecule sensor 1.

In the exemplary embodiment of the present disclosure, the semiconductor substrate 101 is a silicon substrate and the materials of the source insulating portion 102a, the gate insulating portion 102b, the drain insulating portion 102c and the nano-scale semiconductor wire insulating portion 104 are silicon dioxide. The above mentioned first poly-silicon layer is n-type heavy doping and the above mentioned second poly-silicon layer is n-type light doping. It should be appreciated that, the illustrated materials and doping types are not intended to limit scope of the present disclosure. In other words, the above mentioned silicon dioxide can be replaced by other insulating materials. The first poly-silicon layer and the second poly-silicon layer can be p-type heavy doping and p-type light doping depending on the electric property of the molecules, or even the doping types of the first poly-silicon layer and the second poly-silicon layer can be opposite.

In the exemplary embodiment of the present disclosure, the bottom gate 103 can be applied a specified voltage to increase the sensitivity and the accuracy of the molecule sensor 1. When different voltages are applied to the bottom gate 103, the surface charge carriers of the nano-scale semiconductor wire 105b will be increased or decreased accordingly. Therefore, the conductivity of the nano-scale semiconductor wire 105b can be adjusted by applying specified voltages to optimize the sensitivity and the accuracy of the molecule sensor 1.

Besides, the source portion 105a and the drain portion 105c can be connected to an interface circuit or metal wires of other components to form a single chip. The interface circuit or other components may comprise analog and digital control circuits for processing and transmitting sense signals generated from molecule bonding. For example, the interface circuit can be configured to measure the changes of the electrical characteristics of the nano-scale semiconductor wire 105b to generate the sense signals.

Moreover, the molecule sensor 1 of the exemplary embodiment can be implemented by the semiconductor fabrication technology that has two poly-silicon layers and four metal layers. In particular, the molecule sensor 1 can be fabricated by the semiconductor fabrication technology that has two poly-silicon layers and four metal layers to have no decoration layer and have a protective layer thereon. Then, the protective layer of the nano-scale semiconductor wire 105b can be removed by post-fabrication technology, and a decoration layer can be formed on the surface of the nano-scale semiconductor wire 105b by chemical means. Besides, in an exemplary embodiment, the decoration layer can be formed on the protective layer of the nano-scale semiconductor wire 105b without removing the protective layer. For example, the molecule sensor 1 in FIG. 1 can be formed by utilizing isotropic ion etching to remove partial protective layer and utilizing anisotropic etching based on the selection ratio between metal and dielectric to remove remaining protective layer.

A molecule sensor device may comprises a plurality of molecule sensors 1 due to different kinds of molecules, wherein the nano-scale semiconductor wires 105b of the molecule sensors 1 may have different length to width ratios or shapes in response to different kinds of molecules. The interface circuit of the molecule sensor device may comprise selectors or multiplexers to select the molecule to be measured. In addition, the specified voltages on the bottom gates 103 of the plurality of molecule sensors 1 in the molecule sensor device can be different in response to different kinds of molecules. Therefore, the molecule sensor device flexibly provides better sensitivity and accuracy and has better dynamical measurement coverage for different kinds of molecules.

Furthermore, it should be mentioned that, the nano-structure of the bottom gate 103 can be a single-crystal silicon layer or a metal layer. In addition, the source portion 105a, the nano-scale semiconductor wire 105b and the drain portion 105c can be another single-crystal silicon layer. In short, the implementations of the source portion 105a, the nano-scale semiconductor wire 105b and the drain portion 105c are not intended to limit the present disclosure.

Referring to FIG. 3, FIG. 3 is a schematic view illustrating a Wheatstone bridge of a molecule sensor device for detecting sense signals in an embodiment of the present disclosure. The molecule sensor may comprise four sets of nano-scale semiconductor wire, source portion and drain portion to form a Wheatstone bridge. Two nano-scale semiconductor wires without decoration layers are configured as the resistance R1 and R3 of a control group wherein one end thereof receives a bias. The other two nano-scale semiconductor wires with decoration layers are configured as the resistance R1 and R4 of a experimental group wherein one end thereof is grounded.

The difference between the voltage IAVᵢₙ₊ and IAVᵢₙ₋ will not vary in time, referring to the upper half of FIG. 3, because the resistance R1 and R4 will not vary when no molecule is captured by the decoration layer. However, the resistance R1 and R4 will be changed when molecules are captured by the decoration layer so that the difference between the voltage IAVᵢₙ₊ and IAVᵢₙ₋ will vary in time and stop at a specific value, referring to the lower half of FIG. 3. Since the resistance R2 and R3 are known value, the changed value of the resistance R1 and R4 can be calculated based on the final difference between the voltage IAVᵢₙ₊ and IAVᵢₙ₋ for generating sense signals to further detect whether molecules exist and the density variation of molecules.

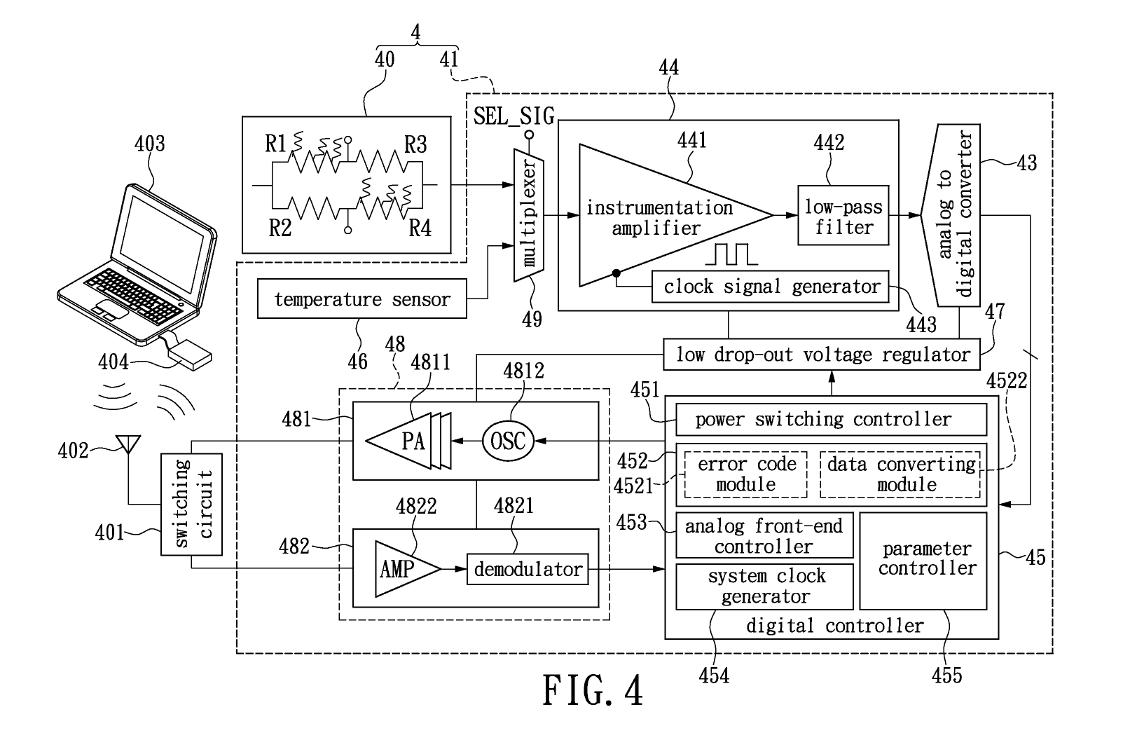

Referring to FIG. 4, FIG. 4 is a block diagram illustrating a molecule sensor device in an embodiment of the present disclosure. The molecule sensor device 4 comprises a molecule sensor 40 and an interface circuit 41. The molecule sensor 40 may comprises four sets of nano-scale semiconductor wire, source portion and drain portion to form a Wheatstone bridge. Such implementation is not intended to limit scope of the present disclosure. The interface circuit 41 is electrically connected to the molecule sensor 40 and a switching circuit 401. The switching circuit 401 is electrically connected to an antenna 402.

The molecule sensor 40 is configured to detect whether molecules exist or the density of molecules to generate sense signals to the interface circuit 41. The interface circuit 41 is configured to process the sense signals and transmit the processed sense signals to the switching circuit 401. The switching circuit 401 transmits the processed sense signals to the computer 403 via the antenna 402. In the exemplary embodiment, the computer 403 is plugged with the wireless LAN card 404 for receiving the processed sense signals. The computer 403 can transmit control signals via the wireless LAN card 404, and the interface circuit 41 can receive the control signals via the antenna 402 and the switching circuit 401 for adjusting parameters and configurations thereof correspondingly. The switching circuit 401 is configured to proceed multiplex transmission for the sense signals and the control signals; namely, the switching circuit 401 transmits the sense signals to the antenna 402 and transmits the control signals to the interface circuit 41 correspondingly.

In the exemplary embodiment, the molecule sensor 40 and the interface circuit 41 can be integrated into a single chip. Extremely, the switching circuit 401 and the antenna 402 can also be integrated with the interface circuit 41 and the molecule sensor 40 into a single chip. In addition, the wireless LAN card 404 can be integrated within the computer 403. In short, these implementations are not intended to limit the present disclosure.

The interface circuit 41 comprises an analog to digital converter 43, a low-noise analog front-end (LN AFE) circuit 44, a digital controller 45, a temperature sensor 46, a low drop-out voltage regulator 47, a transceiver 48 and a multiplexer 49. The temperature sensor 46 and the molecule sensor 40 are electrically connected to the two input ends of the multiplexer 49 respectively. The output end of the multiplexer 49 is electrically connected to the input end of the LN AFE circuit 44. The output end of the LN AFE circuit 44 is electrically connected to the input end of the analog to digital converter 43. The output end of the analog to digital converter 43 is electrically connected to one of the input ends of the digital controller 45. One of the output ends of the digital controller 45 is electrically connected to the input end of the low drop-out voltage regulator 47.

The three out ends of the low drop-out voltage regulator 47 are electrically connected to the power input ends of the transceiver 48, the analog to digital converter 43 and the LN AFE circuit 44 respectively. The other input end and output end of the digital controller 45 are electrically connected to one output end and one input end of the transceiver 48. The other output end and input end of the transceiver 48 are electrically connected to the input and the output end of the switching circuit 401. The input/output end of the switching circuit 401 is electrically connected to the antenna 402.

The temperature sensor 46 is configured to detect the environment temperature to generate temperature signals. The multiplexer 49 receives selecting signal SEL_SIG to select one of the sense signals and the temperature signals for output. The LN AFE circuit 44 is configured to amplify the sense signals or the temperature signals outputted from the multiplexer 49 with low noise.

The LN AFE circuit 44 comprises an instrumentation amplifier 441, a low-pass filter 442 and a clock signal generator 443. The instrumentation amplifier 441 such as rail-to-rail chopper instrument amplifier is configured to amplify the sense signals or the temperature signals and receive the clock signals generated from the clock signal generator 443. The low-pass filter 442 is configured to low-pass filter the sense signals or the temperature signals for filtering out the noise in the sense signals or the temperature signals.

The analog to digital converter 43 is configured to convert the processed sense signals or temperature signals from analog to digital to output digital sense signals or temperature signals. The digital controller 45 receives the control signals from the computer 403 and the digital sense signals or temperature signals, and controls parameters such as switch of the low drop-out voltage regulator 47, gain and bandwidth of the LN AFE circuit 44, output encoding of the digital sense signals or temperature signals and duration and period of the wireless transmission of the molecule sensor device 4 based on the control signals.

The digital controller 45 comprises a power switching controller 451, a data format circuit 452, an analog front-end controller 453, a system clock generator 454 and a parameter controller 455, wherein the data format circuit 452 comprises an error code module 4521 and a data converting module 4522. The power switching controller 451 is configured to control the low drop-out voltage regulator 47 so that the low drop-out voltage regulator 47 can alternately provide power supply to the transceiver 48, the molecule sensor 40, the temperature sensor 46, the analog front-end controller 453 and the analog to digital converter 43. The error code module 4521 is configured to error code encode the digital sense signals or temperature signals, or error code decode the control signals. The data converting module 4522 is configured to convert the data format of the digital sense signals or temperature signals, for example, convert the former data format into the RS232 data format, and decode the received control signals. The analog front-end controller 453 is configured to control the configuration of the LN AFE circuit 44. The system clock generator 454 is configured to generate system clock signals. The parameter controller 455 is configured to control each parameter of the molecule sensor device 4.

The transceiver 48 is configured to modulate the encoded sense signals or temperature signals and demodulate the control signals. The transceiver 48 comprises an on-off keying (OOK) modulator 481 and an OOK receiver 482. The OOK modulator 481 comprises an oscillator 4812 and a power amplifier 4811. When one digit of the digital sense signals or temperature signals is 0, the oscillator 4812 will not output oscillating signals; when one digit of the digital sense signals or temperature signals is 1, the oscillator 4812 will output oscillating signals to the power amplifier 4811. The power amplifier 4811 is configured to amplify the oscillating signals. The OOK receiver 482 comprises an amplifier 4822 and a demodulator 4821. The amplifier 4822 is configured to amplify the control signals. The demodulator 4821 is configured to demodulate the control signals and transmit the demodulated control signals to the digital controller 45. The demodulator 4821 can be an OOK demodulator.

It should be appreciated that, the structure of the interface circuit 41 as illustrated in FIG. 4 is not intended to limit scope of the present disclosure. A manufacturer may design different structures for the interface circuit 41 depending on different demands. For instance, the temperature sensor 46 may be removed from the interface circuit 41 and the multiplexer 49 may also be removed correspondingly. Extremely, a humidity sensor may be added into the interface circuit 41. Besides, the implements of the LN AFE circuit 44, the digital controller 45 and the transceiver may also different from the above descriptions.

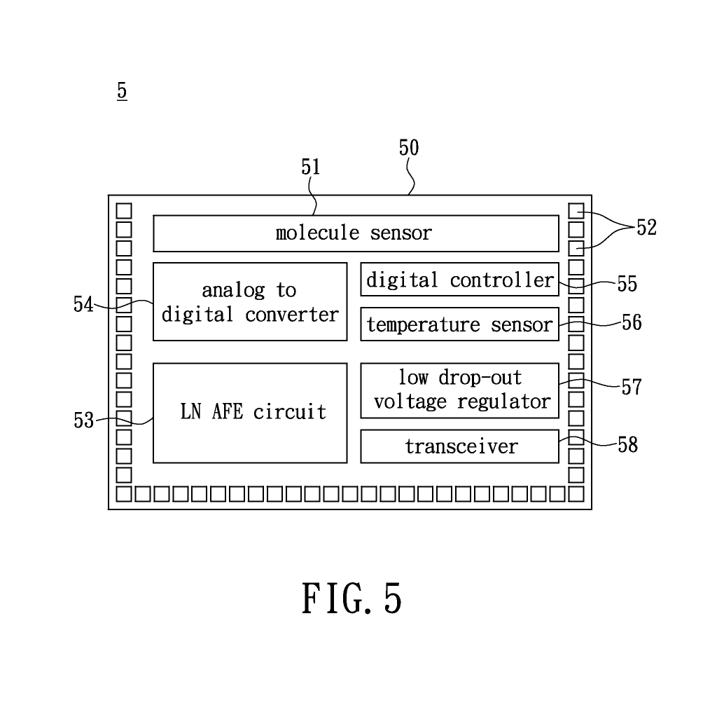

Referring to FIG. 5, FIG. 5 is a plane chart illustrating a single chip of a molecule sensor device in an embodiment of the present disclosure. In FIG. 5, the molecule sensor device 5 comprises a molecule sensor 51, an analog to digital converter 54, an LN AFE circuit 53, a digital controller 55, a temperature sensor 56, a low drop-out voltage regulator 57, a transceiver 58 and a multiplexer (not shown in FIG. 5) which are disposed on a semiconductor substrate 50.

The molecule sensor device 5 further comprises a plurality of pin pads 52. If the molecule sensor device 5 is used for detecting the molecules such as proteins, viruses or deoxyribonucleic acid in aqueous solution, the pin pads 52 have to be spread with waterproof layers and the other components may optionally spread with waterproof layers or not. If the molecule sensor device 5 is merely used for detecting the molecules such as gas molecules, the pin pads 52 may optionally spread with waterproof layers or not.

The molecule sensor device 5 is a single chip which has the advantages of portability, low cost and disposable. The molecule sensor device 5 can be operated by a user for detecting molecules in home environment, and can transmit the detecting results to a remote computer, for example, a server in a medical center, via the transceiver 58 for immediate interpretation by remote doctors. Therefore, the molecule sensor device 5 can be used to compensate the shortage of the professional technical human resources and reduce the spending for the expensive large-scale instruments and thereby to reach the objective of home health care. Moreover, the sensitivity and the accuracy of the molecule sensor device 5 can be further increased by applying specified voltages.

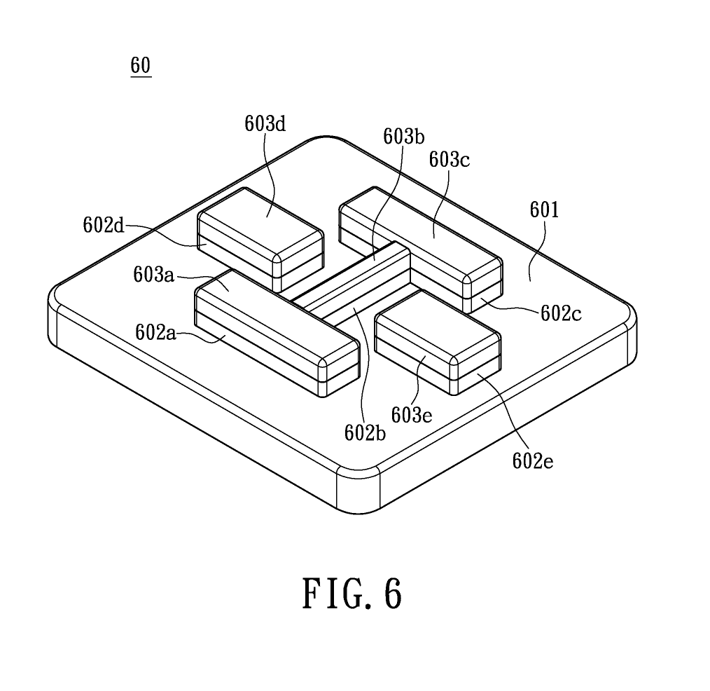

Referring to FIG. 6, FIG. 6 is a solid diagram of a molecule sensor in another embodiment of the present disclosure. The molecule sensor 1 in FIG. 1 may be replaced by the molecule sensor 60 in FIG. 6. The molecule sensor 60 comprises a semiconductor substrate 601, a source insulating portion 602a, a nano-scale semiconductor wire insulating portion 602b, a drain insulating portion 602c, side gate insulating portions 602d and 602e, a source portion 603a, a nano-scale semiconductor wire 603b, a drain portion 603c and side gates 603d and 603e.

The source insulating portion 602a, the nano-scale semiconductor wire insulating portion 602b, the drain insulating portion 602c and the side gate insulating portions 602d and 602e are formed on the semiconductor substrate 601 and can be made from the same insulating layer. The side gates 603d and 603e are formed on the side gate insulating portions 602d and 602e and located at both sides of the nano-scale semiconductor wire 603b respectively. The source portion 603a, the nano-scale semiconductor wire 603b and the drain portion 603c are formed on the source insulating portion 602a, the nano-scale semiconductor wire insulating portion 602b and the drain insulating portion 602c respectively. The nano-scale semiconductor wire 603b is connected between the source portion 603a and the drain portion 603c.

The source insulating portion 602a is configured to electrically insulate the source portion 603a from the semiconductor substrate 601. The drain insulating portion 602c is configured to electrically insulate the drain portion 603c from the semiconductor substrate 601. The nano-scale semiconductor wire insulating portion 602b is configured to electrically insulate the nano-scale semiconductor wire 603b from the semiconductor substrate 601. The side gate insulating portion 602d is configured to electrically insulate the side gate 603d from the semiconductor substrate 601, and the side gate insulating portion 602e is configured to electrically insulate the side gate 603e from the semiconductor substrate 601. The materials of the source portion 603a, the nano-scale semiconductor wire 603b, the drain portion 603c and the side gates 603d and 603e are poly-silicon, and the nano-structure thereof can substantially be the same poly-silicon layer. In addition, in other implementations, the materials of the source portion 603a, the nano-scale semiconductor wire 603b, the drain portion 603c and the side gates 603d and 603e are single-crystal silicon, and the nano-structure thereof can substantially be the same single-crystal silicon layer.

It should be appreciated that, the surface of the nano-scale semiconductor wire 603b is attached a decoration layer for bonding molecules by chemical means. When molecules approach the decoration layer, it will be captured by the decoration layer so that the electrical characteristics of the nano-scale semiconductor wire 603b such as resistance, capacitance or inductance will be changed due to the charged molecules. Briefly speaking, the decoration layer on the surface of the nano-scale semiconductor wire 603b is configured as the sensing region of the molecule sensor 60.

In the exemplary embodiment of the present disclosure, the semiconductor substrate 601 is a silicon substrate and the materials of the source insulating portion 602a, the nano-scale semiconductor wire insulating portion 602b, the drain insulating portion 602c and the side gate insulating portions 602d and 602e are silicon dioxide. In addition, the above mentioned poly-silicon layer is n-type doping. It should be appreciated that, the illustrated materials and doping types are not intended to limit scope of the present disclosure. In other words, the above mentioned silicon dioxide can be replaced by other insulating materials. The poly-silicon layer can be p-type doping depending on the electric property of the molecules.

In the exemplary embodiment of the present disclosure, the side gates 603d and 603e can be applied a specified voltage to increase the sensitivity and the accuracy of the molecule sensor 60. When different voltages are applied to the side gates 603d and 603e, the surface charge carriers of the nano-scale semiconductor wire 603b will be increased or decreased accordingly. Therefore, the conductivity of the nano-scale semiconductor wire 603b can be adjusted by applying specified voltages to optimize the sensitivity and the accuracy of the molecule sensor 60.

Besides, the source portion 603a and the drain portion 603c can be connected to an interface circuit or metal wires of other components to form a single chip. The interface circuit or other components may comprise analog and digital control circuits for processing and transmitting sense signals generated from molecule bonding. For example, the interface circuit can be configured to measure the changes of the electrical characteristics of the nano-scale semiconductor wire 603b to generate the sense signals. Moreover, the molecule sensor 60 of the exemplary embodiment can be implemented by the semiconductor fabrication technology that has a single-crystal silicon layer and six metal layers. Extremely, the molecule sensor 60 of the exemplary embodiment may also be implemented by using silicon-on-insulator (SOI) substrates of single-crystal silicon.

According to the above descriptions, the exemplary embodiment of the present disclosure provides a molecule sensor device. The molecule sensor device comprises at least one molecule sensor. The molecule sensor comprises a bottom gate or a side gate to receive a specified voltage to increase the sensitivity and the accuracy thereof. In addition, the sensor molecule device system is a single chip of system on chip, which is portable or even disposable and the manufacturing cost is low. Accordingly, the molecule sensor device can be used in home health care.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A molecule sensor device, comprising:
at least one molecule sensor, the molecule sensor comprises:
a semiconductor substrate;
a bottom gate, being a single-crystal silicon layer, a poly-silicon layer, or a metal layer formed on the semiconductor substrate and electrically insulated from the semiconductor substrate;
at least one source portion, formed on the semiconductor substrate and electrically insulated from the semiconductor substrate;
at least one drain portion, formed on the semiconductor substrate and electrically insulated from the semiconductor substrate; and
at least one nano-scale semiconductor wire, connected between the source portion and the drain portion, formed on the bottom gate, electrically insulated from the bottom gate, and having a decoration layer thereon for capturing at least one molecule;
wherein the source portion, the drain portion and the nano-scale semiconductor wire are another single-crystal silicon layer or poly-silicon layer, and the bottom gate receives a specified voltage to change an amount of surface charge carriers of the nano-scale semiconductor wire.

2. The molecule sensor device as claimed in claim 1, wherein the molecule sensor further comprises:
a gate insulating portion, formed on the semiconductor substrate, and the bottom gate is formed on the gate insulating portion;
a nano-scale semiconductor wire insulating portion, formed on the bottom gate, and the nano-scale semiconductor wire is formed on the nano-scale semiconductor wire insulating portion;
a source insulating portion, formed on the semiconductor substrate, and the source portion is formed on the source insulating portion; and
a drain insulating portion, formed on the semiconductor substrate, and the drain portion is formed on the drain insulating portion.

3. The molecule sensor device as claimed in claim 1, wherein the poly-silicon layer is n-type doping and the other poly-silicon layer is p-type doping correspondingly, the poly-silicon layer is p-type doping and the other poly-silicon layer is n-type doping correspondingly, both of the poly-silicon layer and the other poly-silicon layer are is n-type doping, or both of the poly-silicon layer and the other poly-silicon layer are is p-type doping.

4. The molecule sensor device as claimed in claim 1, wherein the molecule sensor comprises a plurality of source portions, a plurality of drain portions and a plurality of nano-scale semiconductor wires.

5. The molecule sensor device as claimed in claim 1, wherein the molecule sensor device further comprises:
an interface circuit, being configured to receive a sense signal generated when the molecule is captured by the molecule sensor, process the sense signal, and transmit the processed sense signal to a computer.

6. The molecule sensor device as claimed in claim 5, wherein the interface circuit and the molecule sensor are integrated into a single chip and the molecule sensor device has a plurality of pin pads.

7. A molecule sensor device, comprising:
at least one molecule sensor, the molecule sensor comprises:
a semiconductor substrate;
at least one source portion, formed on the semiconductor substrate and electrically insulated from the semiconductor substrate;
at least one drain portion, formed on the semiconductor substrate and electrically insulated from the semiconductor substrate; and
at least one nano-scale semiconductor wire, connected between the source portion and the drain portion, formed on the bottom gate, electrically insulated from the bottom gate, and having a decoration layer thereon for capturing at least one molecule; and
at least one side gate, formed on the semiconductor substrate, electrically insulated from the semiconductor substrate and located at a side of the nano-scale semiconductor wire;
wherein the source portion, the drain portion, the nano-scale semiconductor wire and the side gate are a single-crystal silicon layer or a poly-silicon layer, and the side gate receives a specified voltage to change an amount of surface charge carriers of the nano-scale semiconductor wire.

8. The molecule sensor device as claimed in claim 7, wherein the molecule sensor further comprises:
a nano-scale semiconductor wire insulating portion, formed on the bottom gate, and the nano-scale semiconductor wire is formed on the nano-scale semiconductor wire insulating portion;
a side gate insulating portion, formed on the semiconductor substrate, and the side gate is formed on the side gate insulating portion;
a source insulating portion, formed on the semiconductor substrate, and the source portion is formed on the source insulating portion; and
a drain insulating portion, formed on the semiconductor substrate, and the drain portion is formed on the drain insulating portion.

9. The molecule sensor device as claimed in claim 7, wherein the poly-silicon layer is n-type doping or p-type doping.

10. The molecule sensor device as claimed in claim 7, wherein the molecule sensor comprises a plurality of source portions, a plurality of drain portions and a plurality of nano-scale semiconductor wires.

11. The molecule sensor device as claimed in claim 7, wherein the molecule sensor device further comprises:
an interface circuit, being configured to receive a sense signal generated when the molecule is captured by the molecule sensor, process the sense signal, and transmit the processed sense signal to a computer.

12. The molecule sensor device as claimed in claim 11, wherein the interface circuit and the molecule sensor are integrated into a single chip and the molecule sensor device has a plurality of pin pads.
